(19) United States
(12) Patent Application Publication
(10) Pub. No.: US 2015/0059952 A1
(43) Pub. Date: Mar. 5, 2015

(54) FILTER ASSEMBLY FOR AIR MAINTENANCE TIRE

(71) Applicant: The Goodyear Tire & Rubber Company, Akron, OH (US)

(72) Inventors: Robert Leon Benedict, Tallmadge, OH (US); Samuel Patrick Landers, North Canton, OH (US); Cheng-Hsiung Lin, Hudson, OH (US); Dinesh Chandra, Stow, OH (US); Carolin Anna Welter, Schleich (DE); Thulasiram Gobinath, Hudson, OH (US); Robin Lamgaday, Wadsworth, OH (US); Patrick David Marks, Uniontown, OH (US); Brian Richard Morris, Uniontown, OH (US); Robert Allen Losey, Kent, OH (US)

(21) Appl. No.: 14/453,676

(22) Filed: Aug. 7, 2014

Related U.S. Application Data
(60) Provisional application No. 61/872,164, filed on Aug. 30, 2013.

(51) Int. Cl. B60C 23/12

(52) U.S. Cl. CPC B60C 23/12
USPC 152/450

(57) ABSTRACT

A tire assembly is disclosed, wherein the tire has a tread portion and a pair of sidewalls extending radially inward from the tread portion to join with a respective bead; a supporting carcass for the tread portion and sidewalls; and a pump passageway positioned within a bending region of the tire. The pump passageway is operative to open and close as the tire rotates. The tire assembly further includes a valve assembly in fluid communication with the pump passageway. The tire further includes a pocket formed in the tire, and a filter assembly is mounted in the pocket. The filter assembly is in air flow communication with the valve assembly, wherein the filter assembly is formed of a housing and a cover, wherein the cover has one or more holes for communicating air into the housing, wherein the cover is connected to the housing, the housing having an interior cavity having a filter media housed therein, the housing having a hole in fluid communication with the valve assembly, wherein a flexible collar surrounds the cover.

### FIELD OF THE INVENTION

The invention relates generally to tires and more specifically, to an air maintenance assembly for a tire.

### BACKGROUND OF THE INVENTION

Normal air diffusion reduces tire pressure over time. The natural state of tires is under inflated. Accordingly, drivers must repeatedly act to maintain tire pressures or they will see reduced fuel economy, tire life and reduced vehicle braking and handling performance. Tire Pressure Monitoring Systems have been proposed to warn drivers when tire pressure is significantly low. Such systems, however, remain dependent upon the driver taking remedial action when warned to re-inflate a tire to recommended pressure. It is a desirable, therefore, to incorporate an air maintenance feature within a tire that will maintain correct air pressure within the tire without a need for driver intervention to compensate for any reduction in tire pressure over time. It is useful to incorporate a filter in the design of an air maintenance tire system, so that the outside air is filtered before entering the system. The filter must be secured to the tire, and be able to sustain rotational forces. The filter must also be designed in such a way to minimize the stresses in the tire and allow for ease of assembly.

### SUMMARY OF THE INVENTION

The invention provides in a first aspect a tire assembly having a tire having a tread portion and a pair of sidewalls extending radially inward from the tread portion to join with a respective bead. The tire has a supporting carcass for the tread portion and sidewalls. A pump passageway is positioned within a bending region of the tire, the pump passageway being operative to open and close as the tire rotates. A valve assembly is in fluid communication with the pump passageway. The tire has a pocket and a filter assembly is mounted in the pocket. The filter assembly is in air flow communication with the valve assembly, wherein the area of the pocket is 20-40% larger than the area of the filter assembly.

The invention provides in a second aspect a tire assembly having a tire having a tread portion and a pair of sidewalls extending radially inward from the tread portion to join with a respective bead; a supporting carcass for the tread portion and sidewalls. A pump passageway is positioned within a bending region of the tire, the pump passageway being operative to open and close as the tire rotates. A valve assembly is in fluid communication with the pump passageway. An elliptical pocket is formed in the tire, wherein the pocket minor axis is aligned with the radial direction of the tire. A filter assembly is mounted in the pocket, said filter assembly being in air flow communication with the valve assembly, wherein the filter assembly is elliptical in shape.

### BRIEF DESCRIPTION OF THE DRAWINGS

The invention will be described by way of example and with reference to the accompanying drawings in which:

FIG. 1 is a front view of tire and rim assembly with a pump, valve and filter assembly.

FIG. 2 is a cross sectional view of a truck tire having a groove in the bead area of the tire;

FIG. 3 is a close up cross-sectional view of the truck tire bead area of FIG. 2 illustrating the pump passageway;

FIG. 4 is a close up cross-sectional view of the truck tire bead area illustrating a filter pocket;

FIG. 5 is a front view of a filter pocket shown in the bead area of the tire;

FIG. 6 is an exploded view of a filter assembly, regulator and tire bead area;

FIG. 7 is a cross-sectional view of the portion of the tire illustrating the filter assembly in the pocket of the tire bead area;

FIG. 8 is a front view of the filter assembly installed in the tire;

FIG. 9 is a front perspective view of the filter assembly;

FIG. 10 is a side cross-sectional view of the filter assembly.

FIG. 11 is a perspective view of the filter housing.

FIG. 12 is a cut away view of the filter housing.

### DETAILED DESCRIPTION OF THE INVENTION

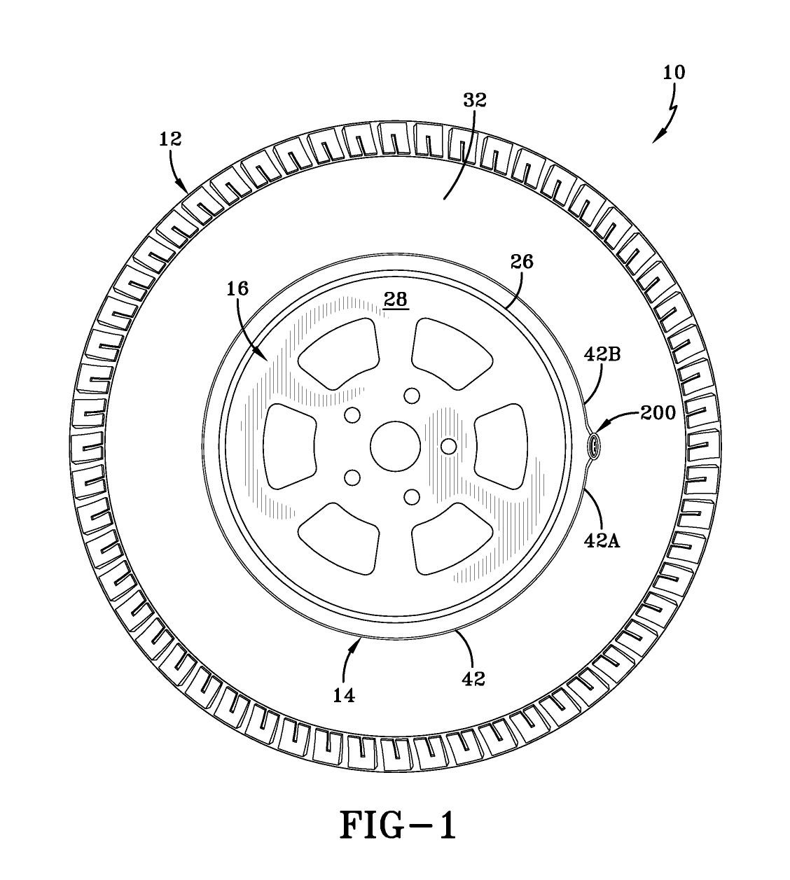

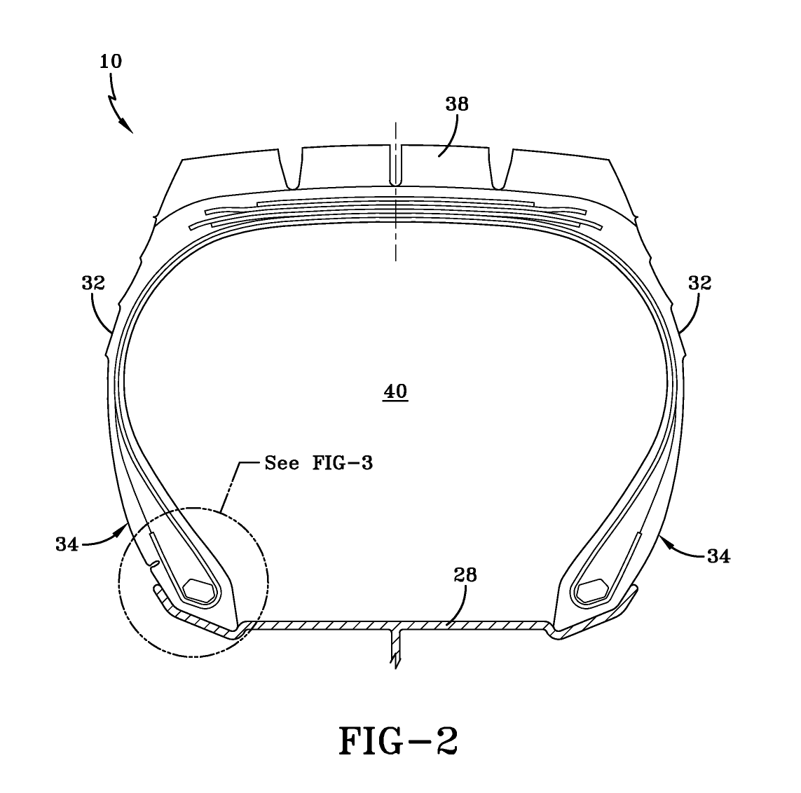

Referring to FIGS. 1 and 2, a tire assembly 10 includes a tire 12 and a pump assembly 14. The tire mounts in a conventional fashion to a wheel 16 having outer rim flanges 22. An annular rim body 28 joins the rim flanges 22 and supports the tire assembly as shown. The tire is of conventional construction, having a pair of sidewalls 32 extending from opposite bead areas 34 to a crown or tire tread region 38. The tire and rim enclose an interior tire cavity 40 which is filled with air.

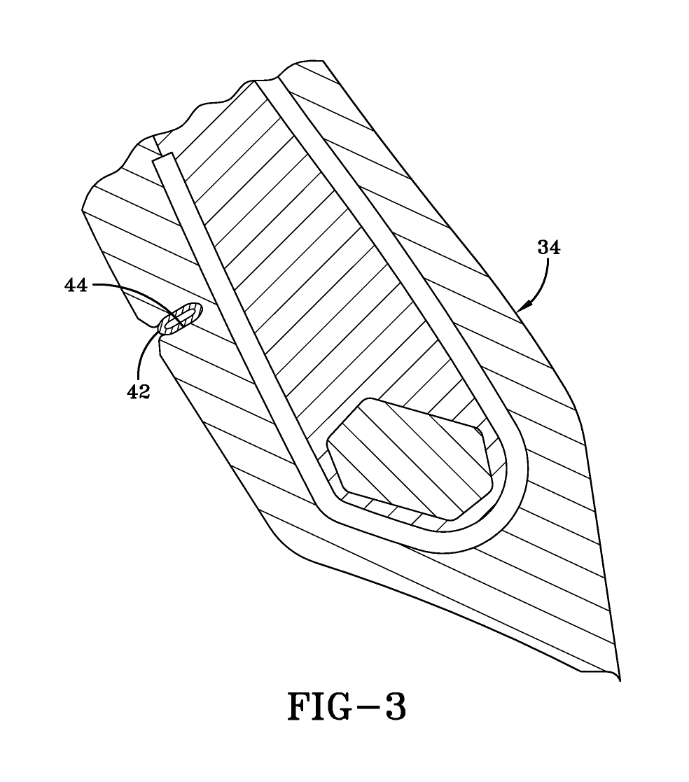

As shown in FIGS. 1 and 3, the tire assembly includes a pump 14 having a pump passageway 42 that is mounted or located in the tire in a channel 44, preferably near the bead region 34 of the sidewall. The pump passageway 42 may be formed of a discrete tube made of a resilient, flexible material such as plastic, elastomer or rubber compounds, and is capable of withstanding repeated deformation cycles when the tube is deformed into a flattened condition subject to external force and, upon removal of such force, returns to an original condition. The tube is of a diameter sufficient to operatively pass a volume of air sufficient for the purposes described herein and allowing a positioning of the tube in an operable location within the tire assembly as will be described. Preferably, the tube has an elliptical cross-sectional shape, although other shapes such as round may be utilized.

The pump passageway itself may also be integrally formed or molded into the sidewall of the tire during vulcanization, eliminating the need for an inserted tube. An integrally formed pump passageway is preferably made by building into a selected green tire component such as a chafer, a removable strip made of wire or silicone. The component is built into the tire and cured. The removable strip is then removed post cure to form a molded in or integrally formed pump air passageway.

Hereinafter, the term “pump passageway” refers either to installed tubes or an integrally molded in passageway. The location selected for the pump passageway within the tire may be within a tire component residing within a high flex region of the tire, sufficient to progressively collapse the internal hollow air passageway as the tire rotates under load thereby conveying air along the air passageway from the inlet to the pump outlet.

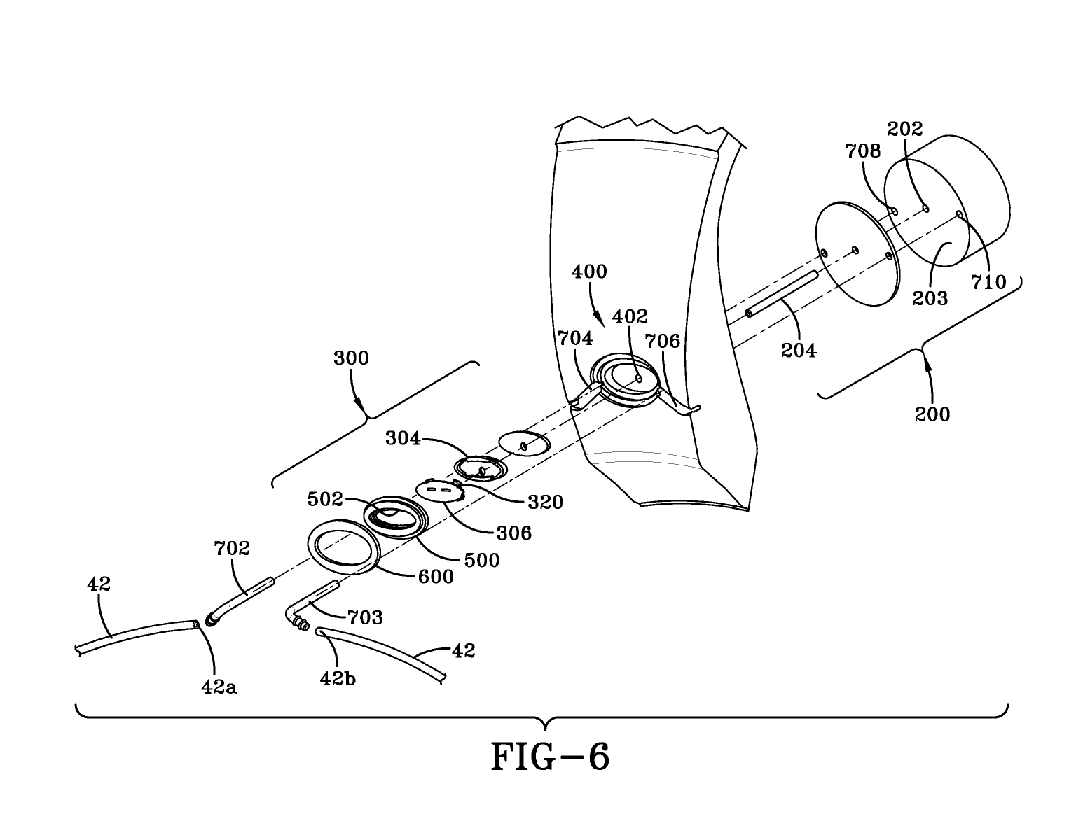

The pump air passageway 42 has an inlet end 42a and an outlet end 42b joined together by a valve system 200, as shown in FIGS. 1, 6. Examples of pressure regulators or valve systems suitable for use with the invention are disclosed in U.S. application Ser. Nos. 13/221,231, 13/221,433 and 13/221,506 and are hereby incorporated by reference. As shown in this particular example, the inlet end 42a and the outlet end 42b are spaced apart approximately 360 degrees forming an annular pump assembly. However, the inlet and outlet ends may be spaced apart 90°, 180°, etc.

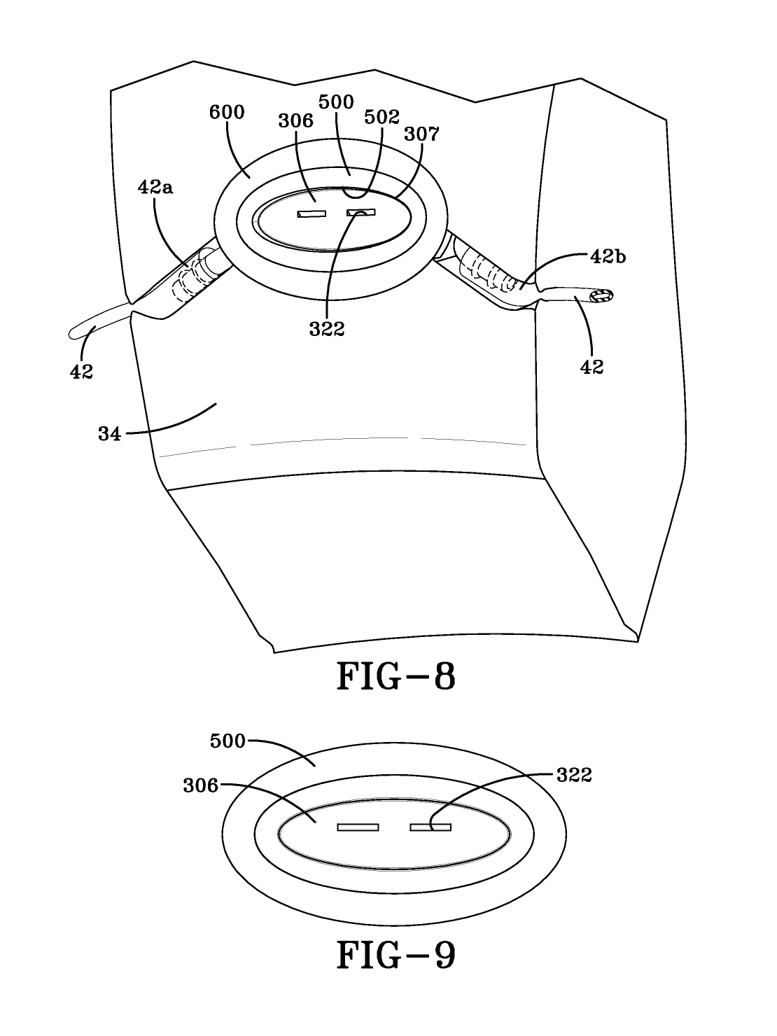

The valve assembly 200 is preferably affixed to the inside of the tire, near the bead area. The valve assembly 200 has an inlet port 202 that is in fluid communication with a central air conduit 204. The central air conduit 204 is in fluid communication with an air filter assembly 300, as shown in FIGS. 6-8. The central air conduit is preferably a flexible tube or passageway that extends from a filter housing to the inlet port 202 of the valve assembly 200.

The valve assembly 200 is operable to control the amount of inlet air to the pump system 42. If the tire cavity pressure 40 falls below a set trigger pressure, the valve device allows air to enter the valve assembly 200 through inlet port 202, and then through to the pump passageway 42. The valve assembly 200 may allow airflow into the pump system through an air inlet port 210. The valve assembly 200 also may control the flow of air from the pump into the tire cavity, as well as prevent cavity air from back flowing into the pump passageways.

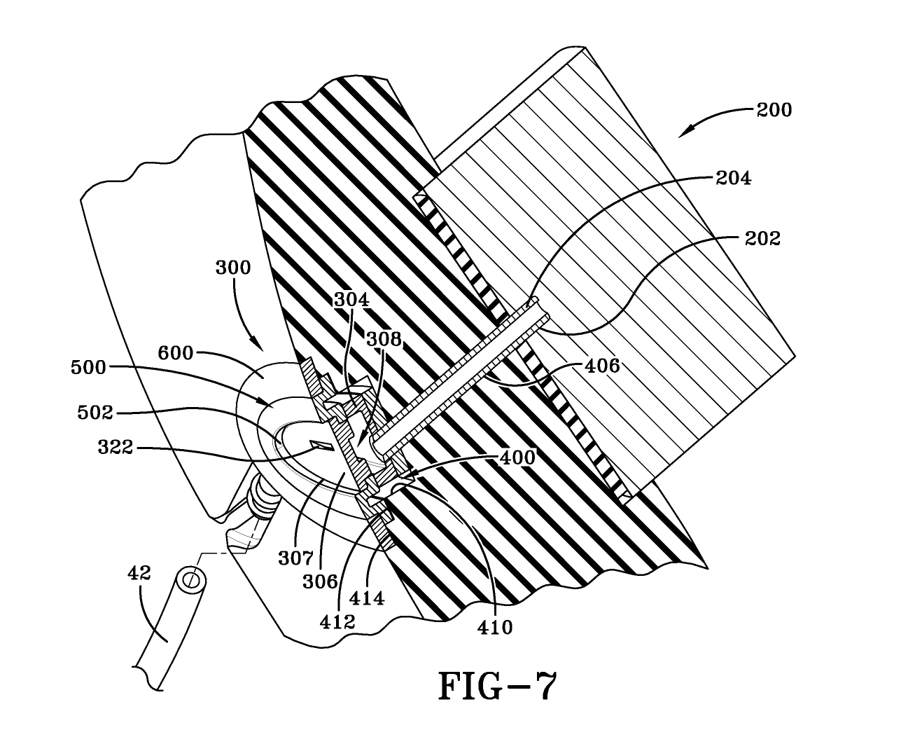

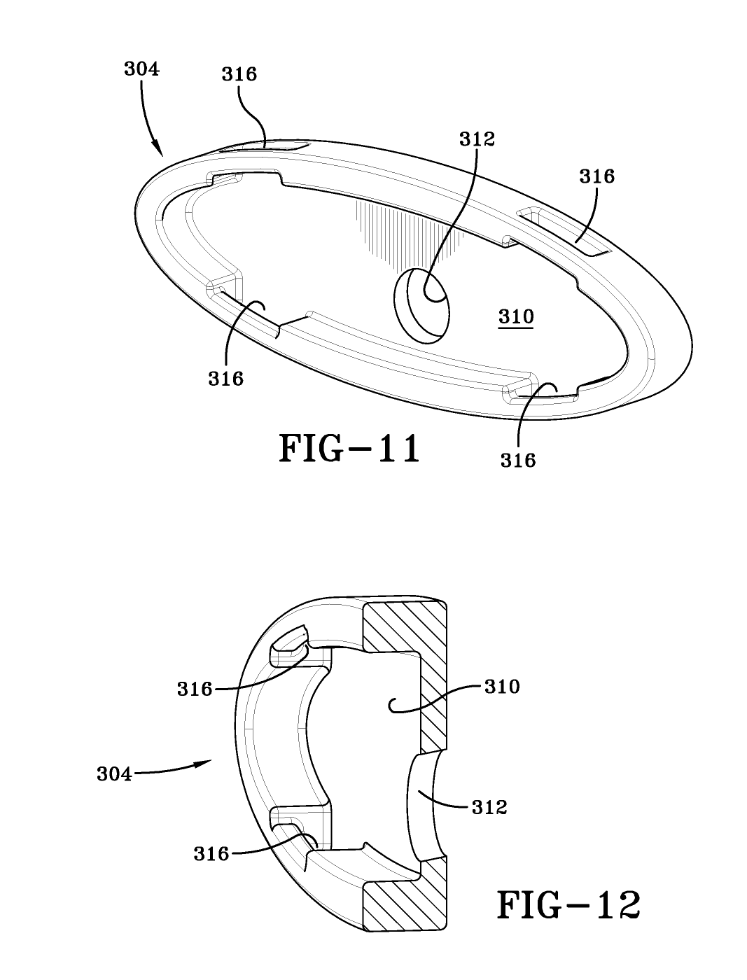

The air filter assembly 300 is preferably positioned on the outer sidewall of the tire, in the vicinity of the pump passageways, as shown in FIGS. 6-8. However, other locations may be used. The air filter assembly filters the outside air and communicates the filtered air to the inlet port 202 of the valve assembly 200. The air filter assembly 300 has a housing 304, and a cover 306 which assemble together to form an internal cavity 308. The filter housing 304 is shown in FIGS. 7, 10, 11 and 12. The filter housing 304 is also preferably elliptical in shape, with the minor axis aligned with the radial direction of the tire. The bottom surface 310 of the filter housing has a hole 312 for reception of a first end of the central air conduit 204. The filter housing has a sidewall 314 having cutouts 316. Tabular ends 320 of the cover 306 are received in the cutouts 316 to attach the cover to the filter housing. The front face of the cover has one or more holes 322. The filter housing 304 and cover 306 may be made of hard plastic or metal.

One or more layers of filter media 550 is received in the internal cavity 308 of the filter assembly 300. The filter media may be a woven or nonwoven fiber, foam, spun fiberglass, charcoal, or other materials known to those skilled the art. Alternatively, a membrane such as PTFE GoreTex may be used, alone or in combination with the filter media.

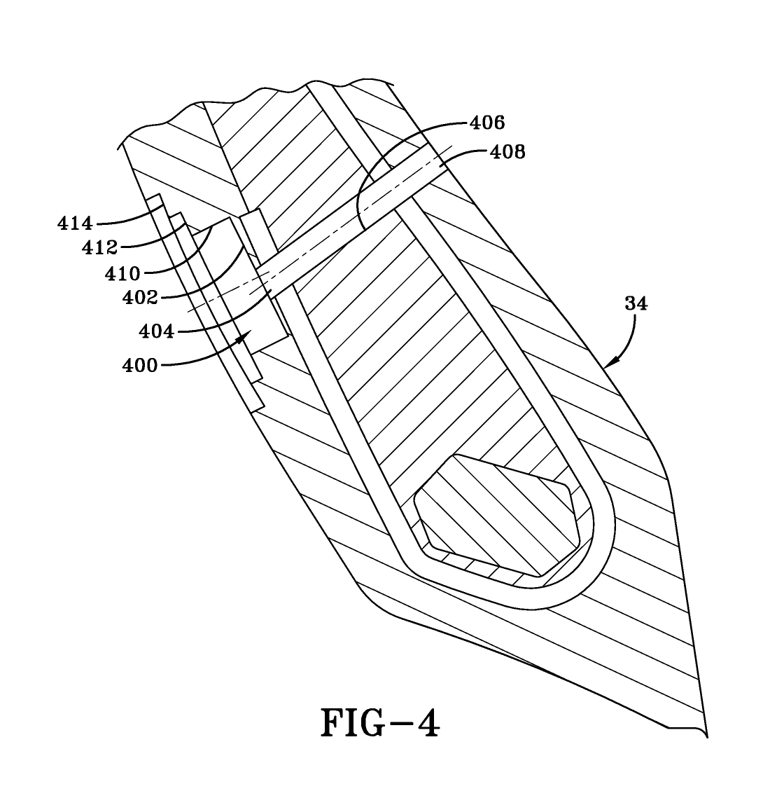

The air filter assembly 300 is mounted in a pocket 400 formed on the outer surface of the tire, typically in the sidewall area near the pump passageways. The pocket 400 is shown in FIGS. 4-6. The pocket may be molded in the tire (not shown), or formed in a vulcanized tire, post cure by laser cutting.

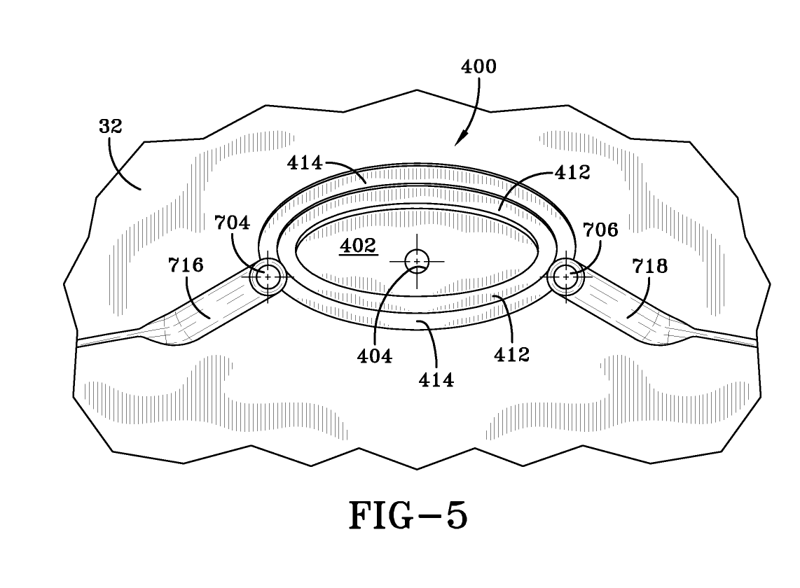

As shown in FIG. 5, the general shape of the pocket 400 is curved, with no corners to eliminate stress concentrations. It is preferred that the pocket is also elliptical in shape, with the minor axis of the ellipse aligned with the radial direction of the tire. The pocket may also be round. The depth of the pocket is about 5-15 mm, and the major axis width is about 20-40 mm, minor axis width is about 8-15 mm. The pocket has a bottom surface 402 having a hole 404 that is connected to the passageway 406 formed through the tire to the tire cavity, so that fluid may communicate from the hole 404 in the pocket to the passageway exit 408. An optional central air conduit 204 is positioned in the passageway 406 to communicate filtered air to the valve assembly 200. Alternatively, the passageway 406 may be used to communicate fluid to the cavity from the pocket.

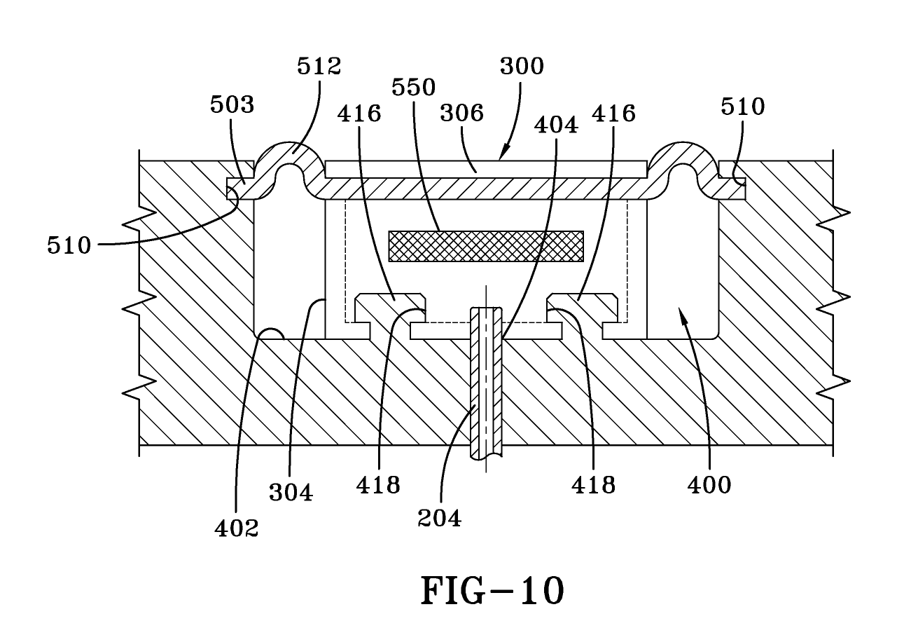

The bottom surface 402 of the pocket may further optionally include molded in attachment knobs 416 as shown in FIG. 10. The attachment knobs 416 may be used to secure a filter housing to the pocket. The bottom of the filter housing may have recesses 418 which allow the knobs 416 to snap inside, as shown in FIG. 10. Alternatively, the filter housing may have knobs (not shown) which are secured into recesses of the pocket (not shown).

The pocket 400 further includes a sidewall 410. The sidewall 410 is surrounded by a first and second ledge 412, 414 joined together. A flexible collar 500 has an interior hole 502 wherein the interior hole is positioned around the outer circumferential edge 307 of the cover 306. The flexible collar 500 has a second end positioned on the first ledge 412. Alternatively, the second end may be positioned in a slot 510 formed in the sidewall of the pocket, as shown in FIG. 10. The cross-sectional profile 512 of the flexible collar may be U shaped. The flexible collar allows for the +/−10% sidewall strain seen in tire service while protecting the filter media from flexing. The flexible collar 500 is made from a flexible material such as rubber.

A green (unvulcanized) rubber ring 600 has an inner hole that is positioned about the outer circumference of the flexible collar 500 and wherein the outer portion of the rubber ring is positioned on the second, outer ledge 414. The green rubber ring 600 has an inner side which is coated with a suitable adhesive as described below. The green rubber ring 600 is then cured over the flexible collar and affixed to the sidewall of the tire. The green rubber ring 600 may be cured by heat.

As shown in FIGS. 7 and 10, the filter housing major axis dimension and minor axis dimension is smaller than the pocket internal cavity 308, such that there is a gap surrounding the filter housing. The spatial gap can be in the range of 2 mm to about 8 mm. Thus the filter housing major axis dimension may be in the range of 10% to 50% smaller than the pocket major axis dimension, and more preferably, 20-30% smaller than the pocket major axis dimension.

The bottom of the filter housing is attached to the pocket bottom surface 402 by using one or more strips of green unvulcanized rubber which are coated with a suitable adhesive on both sides. The adhesive may be heat cured or cured at room temperature. One suitable adhesive is Fast Dry Self-vulcanizing Cement made by the Rubber Patch Company.

Adjacent the pocket are two holes 704, 706 as shown in FIG. 5. The holes 704, 706 extend through the sidewall of the tire and are in fluid communication with aligned holes 708, 710 of the regulator. Pump tubes 702, 704 have a first end 703, 705 that are inserted through holes 704, 706 and into regulator holes 708, 710. Pump tubes 702, 704 preferably have quick connect ends such as barbs, etc. so that the system may be easily assembly. Pump tubes 702,704 are preferably made of high strength polyurethane. Pump tubes have a second end 712, 714 that are bent about 90°. The second ends 712, 714 are inserted into slots 716, 718 formed adjacent the pocket. The second ends 712, 714 of the pump tubes connect to a continuous pump passageway 42.

The pump passageway is connected to the second ends of the pump tubes, and then the pump passageway is inserted into channel 44. Preferably, the pump passageway is coated with rubber cement and then inserted into the pump passageway. A green cover strip of rubber having an inner surface is first coated with rubber cement and then is placed over the pump passageway in the annular channel. Heat may be used to cure the rubber cement.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire assembly comprising:
a tire having a tread portion and a pair of sidewalls extending radially inward from the tread portion to join with a respective bead; a supporting carcass for the tread portion and sidewalls;
a pump passageway positioned within a bending region of the tire, the pump passageway being operative to open and close as the tire rotates;
a valve assembly in fluid communication with the pump passageway;
a pocket formed in the tire;
a filter assembly mounted in the pocket, said filter assembly being in air flow communication with the valve assembly, wherein the pocket has an area larger than the area of the filter housing.

2. The tire assembly of claim 1 wherein the area of the pocket is 10-30% larger than the area of the filter housing.

3. The tire assembly of claim 1 wherein the filter assembly has the shape of an ellipse.

4. The tire assembly of claim 2 wherein the ellipse has a major axis and a minor axis, wherein the minor axis of the filter assembly is aligned with the radial direction of the tire.

5. The tire assembly of claim 1 wherein the pocket is formed in the sidewall of the tire.

6. The tire assembly of claim 1 wherein the pocket has a bottom surface, wherein the bottom surface has a hole connected to a channel formed in the tire wall, wherein the hole is in fluid communication with the valve assembly through the channel.

7. The tire assembly of claim 5 wherein the pocket is elliptical in shape, and having a minor axis aligned with the radial direction of the tire.

8. The tire assembly of claim 1 wherein the valve assembly has an inlet, wherein the filter assembly has an outlet, wherein a tube connects the filter outlet assembly to the inlet of the valve assembly.

9. The tire assembly of claim 7 wherein the tube is made of polyurethane.

10. The tire assembly of claim 7 wherein the tube has barbs on each end for a quick connection.

11. The tire assembly of claim 7 wherein the tube has quick connects on each end.

12. The tire assembly of claim 7 wherein the tube has pressure fittings on each end for a quick connection.

13. The tire assembly of claim 1 wherein the filter assembly is formed of a housing and a cover, wherein the cover has one or more holes for communicating air with the housing, wherein the cover is connected to the housing, the housing having an interior cavity for receiving the filter media, the housing having a hole for fluid communication with the valve assembly, wherein a flexible collar surrounds the cover.

14. The tire assembly of claim 12 wherein the flexible collar is made of rubber.

15. The tire assembly of claim 12 wherein the cross-sectional shape of the collar is U-shaped.

16. A tire assembly comprising:
a tire having a tread portion and a pair of sidewalls extending radially inward from the tread portion to join with a respective bead; a supporting carcass for the tread portion and sidewalls;
a pump passageway positioned within a bending region of the tire, the pump passageway being operative to open and close as the tire rotates;
a valve assembly in fluid communication with the pump passageway;
an elliptical pocket formed in the tire, wherein the pocket minor axis is aligned with the radial direction of the tire;
a filter assembly mounted in the pocket, said filter assembly being in air flow communication with the valve assembly, wherein the filter assembly is elliptical in shape.

17. The tire assembly of claim 16 wherein the minor axis of the filter assembly is in the range of 10% to 50% smaller than the minor axis of the pocket.

18. The tire assembly of claim 16 wherein the minor axis of the filter assembly is in the range of 15% to 30% smaller than the minor axis of the pocket.

19. The tire assembly of claim 16 wherein the filter media is a porous membrane.

20. A tire assembly comprising:
a tire having a tread portion and a pair of sidewalls extending radially inward from the tread portion to join with a respective bead; a supporting carcass for the tread portion and sidewalls;
a pump passageway positioned within a bending region of the tire, the pump passageway being operative to open and close as the tire rotates;
a valve assembly in fluid communication with the pump passageway;
a pocket formed in the tire,
a filter assembly mounted in the pocket, said filter assembly being in air flow communication with the valve assembly, wherein the filter assembly is formed of a housing and a cover, wherein the cover has one or more holes for communicating air into the housing, wherein the cover is connected to the housing, the housing having an interior cavity having a filter media housed therein, the housing having a hole in fluid communication with the valve assembly, wherein a flexible collar surrounds the cover.

21. The tire assembly of claim 20 wherein the flexible collar is made of rubber.

22. The tire assembly of claim 20 wherein the cross-sectional shape of the flexible collar is U shaped.

23. The tire assembly of claim 20 wherein the flexible collar has an inner hole for reception about the outer surface of the cover, and an outer surface of the flexible collar is secured within a slot of the sidewall of the pocket.
